(19) United States
(12) Patent Application Publication
(10) Pub. No.: US 2005/0200704 A1
(43) Pub. Date: Sep. 15, 2005

(54) Imager and stripe noise removing method

(76) Inventors: Toshiaki Kodake, Kanagawa (JP); Katsumi Katoh, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 10/506,735

(22) PCT Filed: Mar. 5, 2003
(86) PCT No.: PCT/JP03/02566

§ 371 Date: May 27, 2005

(30) Foreign Application Priority Data
Mar. 5, 2002 (JP) 2002-058500

(51) Int. Cl. H04N 5/225

(52) U.S. Cl. 348/207.99

(57) ABSTRACT

An image pickup apparatus which can remove flickers appearing in a frame of a solid-state image pickup device is disclosed. A light amount detector (2) is provided in the proximity of a sensor light receiving section (1), and the amount of light incoming to the sensor light receiving section (1) is normally monitored by the light amount detector (2). Detection data of the light amount detector (2) is signaled to a light amount detection data processing section (correction value calculation section) (4). The light amount detection data processing section (4) detects a current light amount condition based on the detection data inputted thereto and calculates correction data for removal of flickers based on the detected current light amount condition. A microcomputer performs an calculation process to obtain a maximum value and a minimum value of the light amount to detect the period of light emission of a light source. Then, an inverse number of an integration value of the light amount is multiplied by the image pickup signal such that the phase is displaced by 90° with respect to the light emission period of the light source to perform correction. The correction is performed by sending the correction data to a multiplier (gain amplifier) section (7).

### TECHNICAL FIELD

This invention relates to an image pickup apparatus which uses a solid-state image pickup device and a noise removing method for the image pickup apparatus, and more particularly provides a countermeasure for removing striped noise appearing in a frame notably in a solid-state image pickup device.

### BACKGROUND ART

Conventionally, a CMOS sensor is known as one of solid-state image pickup devices.

In particular, the CMOS sensor has an image pickup region in which a large number of photo-sensors corresponding to image pickup pixels are disposed in a matrix, and includes a gate circuit formed from a plurality of MOS transistors and disposed for each pixel for selectively reading out signal charge from each photo-sensor. The CMOS sensor further includes address scanners for a vertical direction and a horizontal direction for driving the gate circuits of the pixels to read out the signal charge from the pixels.

The CMOS sensor further includes a shutter scanner incidentally to the address scanners and has an electronic shutter function of canceling signal charge remaining in the photo-sensors prior to a charge accumulation period. In other words, the electronic shutter in this instance scans lines of the image pickup pixels in a vertical direction to successively perform a shutter operation.

It is known that, in a CMOS sensor of the type described, if the electronic shutter function is used to suitably select the exposure time in accordance with a light emission timing of a fluorescent lamp, then striped noise can be eliminated. An example of the striped noise here is flickers. (The following description is given in connection with flickers.) For example, where a fluorescent lamp is driven by a power supply of 50 Hz, it exhibits variations of the emitted light amount in a waveform of a period of 1/100 second (for example, refer to FIG. 2), but where the fluorescent lamp is driven by another power supply of 60 Hz, it exhibits variations of the emitted light amount in another waveform of another period of 1/120 second.

Therefore, if the minimum control unit of a shutter operation is set to 1/100 second or 1/120 second and a charge accumulation period (exposure time=shutter value) equal to an integral number of times the minimum control unit is selected, then any displacement between the period of the shutter operation and the period of the light amount variation waveform can be eliminated and a light amount variation (that is, an amount between the top and the bottom of the light amount variations) can be allocated equally to the charge accumulation periods of the lines. Consequently, flickers can be eliminated.

However, roughly speaking, the method described above has two problems:
(1) How to detect flickers; and
(2) Since the shutter value is fixed, attention must be paid to maintenance of the luminance level in the succeeding stage.

Here, as regards the detection of flickers of the item (1), a problem takes place that it is determined simply in error that the image pickup subject itself has a striped pattern and the shutter value is fixed in an unnecessary condition. Further, special hardware for the detection is required separately, and the burden on software increases significantly as the detection performance increases.

Meanwhile, where the shutter value is fixed as in the item (2), attention should be paid to overexposure at a high illuminance and to deterioration of the SN ratio by gain control at a low illuminance.

As regards the overexposure at a high illuminance, it is necessary to cancel the fixation of the shutter value and return the shutter function to a variable condition. In other words, it is necessary to take a clear-cut attitude that a countermeasure against flickers by the shutter cannot be applied at a high illuminance.

On the other hand, as regards the problem of the degradation of the SN ratio at a low illuminance, unnecessary gain application can be avoided to a certain degree by setting an appropriate minimum control unit and selecting a shutter speed as described hereinabove. However, it cannot be avoided to cope with the program by gain adjustment of 0 to 6 dB for a period of time until 2/100 seconds (or 2/120 seconds) are reached at least maintaining, for example, 1/100 second (or 1/120 second).

Therefore, it is an object of the present invention to provide an image pickup apparatus and a striped noise removing method for the image pickup apparatus by which striped noise appearing in a frame of a solid-state image pickup device can be removed.

### DISCLOSURE OF INVENTION

In order to attain the object described above, according to the present invention, there is provided an image pickup apparatus, comprising a solid-state image pickup device for outputting an image pickup signal corresponding to the amount of light incoming to a light receiving face thereof, a light amount detector for measuring the received light amount, and a correction circuit for detecting periodical variations of the received light amount from a detection output of the light amount detector and correcting the image pickup signal from the solid-state image pickup device with the detected periodical variations of the received light amount.

Further, according to the present invention, there is provided a striped noise removing method for an image pickup apparatus which includes a solid-state image pickup device for outputting an image pickup signal corresponding to the amount of light incoming to a light receiving face thereof, wherein a light amount detector for measuring the received light amount is provide in the proximity of the light receiving face of the solid-state image pickup device, and periodical variations of the received light amount caused by the frequency of a power supply are detected from a detection output of the light amount detector and the image pickup signal from the solid-state image pickup device is corrected with the detected periodical variations of the received light amount to remove at least part of striped noise arising from a periodical light emission characteristic of the light source.

With the image pickup apparatus, by detecting periodical variations of the received light amount from a detection output of the light amount detector and correcting an image pickup signal from the solid-state image pickup device with the detected periodical variations, at least part of noise arising from periodical variations of the incoming light amount can be removed.

On the other hand, with the striped noise removing method for an image pickup apparatus of the present invention, by detecting periodical variations of the received light amount by a power supply frequency from a detection output of the light amount detector provided in the proximity of the light receiving face of the solid-state image pickup device and correcting an image pickup signal from the solid-state image pickup device with the detected periodical variations, striped noise arising from a periodical light emission characteristic of the light source can be eliminated. Consequently, it is possible to appropriately detect and remove striped noise arising from the light source.

### BRIEF DESCRIPTION OF DRAWINGS

FIG. 1 is a block diagram showing a general configuration of an image pickup apparatus according to an embodiment of the present invention;

FIG. 2 is a diagram illustrating variations of the emitted light amount of a fluorescent lamp with respect to passage of time;

FIG. 3 is a diagrammatic view illustrating a principle of appearance of flickers;

FIG. 4 is a schematic view showing an example of a screen on which flickers appear;

FIG. 5 is a diagrammatic view illustrating an example of an emitted light amount of a light source and a light source integration value;

FIG. 6 is a schematic view showing an example wherein a light amount detector which can spectralize light by means of color filters is provided; and

FIG. 7 is a diagrammatic view illustrating a persistence characteristic by a fluorescent material of a fluorescent lamp.

### BEST MODE FOR CARRYING OUT THE INVENTION

In the following, an embodiment of an image pickup apparatus and a striped noise removing method for the image pickup apparatus according to the present invention is described.

It is to be noted that, while the embodiment described below is an example of a preferred form to which the present invention is applied and has various technically preferable restrictions applied thereto, the scope of the present invention shall not be restricted to the specific form unless it is specifically described in the following description that the present invention should be restricted. For example, flickers are used only as an example of striped noise arising from periodical variations of the received light amount by a light receiving element.

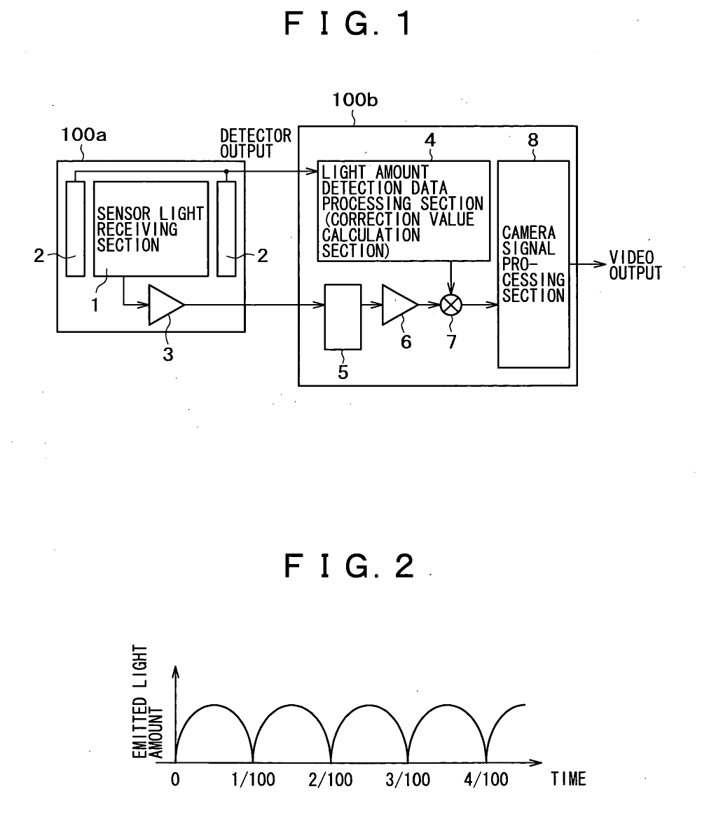

FIG. 1 is a block diagram showing a general configuration of an image pickup apparatus according to an embodiment of the present invention.

The image pickup apparatus according to the present embodiment uses a CMOS sensor for a solid-state image pickup device and includes a light amount detector provided in the CMOS sensor and capable of measuring the amount of light. An image pickup signal output of the CMOS sensor is corrected based on a detection value of the light amount detector to remove striped noise (flickers) in a frame arising from a periodical light emission characteristic of a fluorescent lamp or the like.

First, a principle of appearance of flickers is described prior to the description of such an image pickup device according to the present embodiment as just described.

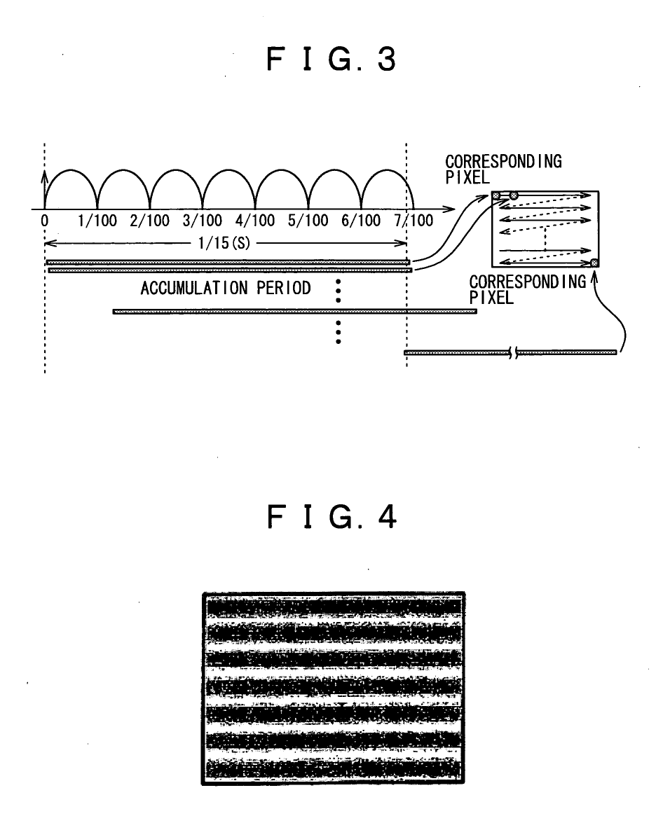

First, the amount of a fluorescent lamp varies in a period equal to ½ the period of a power supply as seen in FIG. 2. For example, where a power supply of 50 Hz is used, the fluorescent lamp has a light amount variation period of 1/100. Where such a light source as just described is used for illumination, if an image of an image pickup subject is picked up by an image pickup device having an exposure mechanism which uses a scanning operation as a shutter operation like a CMOS sensor, then such striped flickers as seen in FIG. 4 appear in accordance with such a principle as illustrated in FIG. 3.

FIG. 3 illustrates fluorescent lamp light emission timings and exposure timings of a CMOS sensor where a 50 Hz power supply is used.

If it is assumed here that the frame rate of the CMOS sensor is, for example, 15 FPS (frames/second), then emission of light from the fluorescent lamp is performed more than six times while exposure of one frame is performed.

Thus, since the exposure timing of the CMOS sensor differs among different pixels, whether the light amount integration value is high or low appears as it is on an actual image.

There is a tendency that, if it is assumed that the frame rate is slowed down to twice and hence to 7.5 FPS, then also the number of stripes increases to twice.

Therefore, in the present embodiment, a light amount detector is prepared in a CMOS sensor section, and a correction value is calculated based on the light amount detection value. Then, the correction value is used to perform a correction process directly for image data at some processing stage among succeeding stages.

In the following, the present invention is described in detail in connection with an example of a configuration of the image pickup apparatus shown in FIG. 1.

First, roughly speaking, the image pickup apparatus of the present embodiment includes a CMOS sensor section 100a and a signal processing section 100b.

The CMOS sensor section 100a includes a sensor light receiving section 1, a light amount detector 2, an analog gain control section 3 and so forth. In the example shown, a pair of light amount detectors 2 are disposed on the opposite sides of the central sensor light receiving section 1.

It is to be noted that, although the CMOS sensor section 100a includes, as other components, an internal timing generation circuit and an address scanning circuit for driving the CMOS sensor, a communication block and so forth, since they have no direct relation to a characteristic function of the present invention, description of them is omitted herein.

Meanwhile, the signal processing section 100b includes a light amount detection data processing section (correction value calculation section) 4, an A/D conversion section 5, a digital gain control section 6, a multiplier (gain amplifier) section 7, a camera signal processing section 8 and so forth. The signal processing section 100b performs various signal processes for an image pickup signal from the CMOS sensor section 100a and outputs a final video signal.

Subsequently, operation of the image pickup apparatus having such a configuration as described above is described principally in regard to a flicker removing method.

First, from the sensor light receiving section 1, similarly to a conventional CMOS sensor, image signals having exposure timings different among different lines while the exposure period is common are outputted. The image output of the sensor light receiving section 1 is gain controlled based on a parameter value communicated in advance by the analog gain control section 3 and outputted.

Meanwhile, detection data outputted from the light amount detector 2 is used to normally monitor the light amount at the point of time. In other words, the detection data is not outputted in synchronism specifically with a horizontal/vertical scanning signal, but a transition with respect to time of the emitted light amount of a light source illustrated in FIG. 2 is obtained directly. It is to be noted that, in the example shown in FIG. 1, the two light amount detectors 2 are disposed on the left and right, and outputs of the light amount detector 2 are added and signaled to the light amount detection data processing section 4 of the signal processing section 100b.

The light amount detection data processing section (correction value calculation section) 4 detects the current light amount condition based on the detection data inputted and calculates correction data based on the detected light amount condition in accordance with a technique described below.

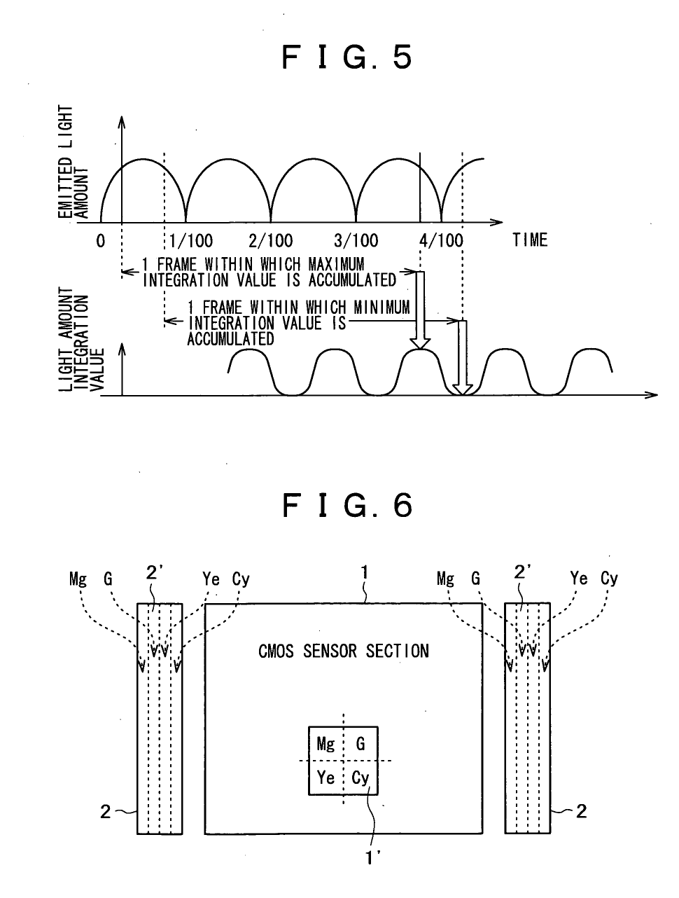

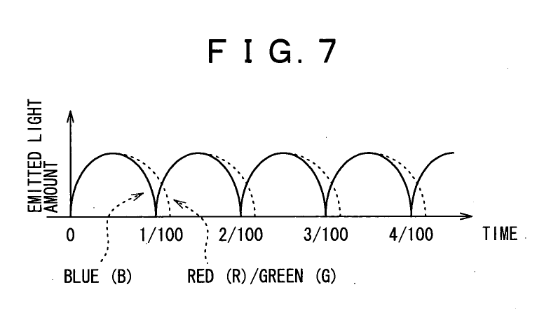

It is to be noted that several implementation methods are available as means for calculating a particular correction amount. For example, a microcomputer is built in the signal processing section 100b and detects maximum/minimum values of the light amount as seen in FIG. 5 to detect the light emission period of the light source. Then, the inverse number of the light amount integration value is processed so as to be multiplied by the image pickup signal such that the phase with respect to the light emission period of the light source is displaced by 90°.

The timing at which the microcomputer detects the current light amount state is preferably acquired by interrupting the microcomputer in synchronism with a horizontal synchronizing signal or acquired so that the sampling period may be fixed using a built-in timer.

Also when it is tried to implement the light amount detection data processing section (correction value calculation section) 4 using hardware, this can be implemented based on the same idea.

Further, operation of the light amount detection data processing section (correction value calculation section) 4 is described.

First, since the emitted light amount of a fluorescent lamp does not exhibit an ideal sine wave, it is considered that also the light amount integration value does not make an accurate sine wave.

Therefore, such a configuration is used that a waveform of a light amount integration value for one period is stored (correction values for the light amount detection value are produced and stored as an address mapping table in advance) and is used to read out a correction value.

Consequently, a correction value for an emitted light amount can be found accurately, and precise correction can be performed. Further, if a light source can be specified to a certain degree, then the waveform to be stored may have empirical values set in advance.

Further, while the position at which a correction amount is multiplied by the multiplier (gain amplifier) section 7 is inserted in a position at which all gain control is completed in FIG. 1 (that is, in a stage next to the digital gain control section 6), this does not particularly restrict the position.

In particular, the position may be any of the following positions.

(1) Preceding to the analog gain control section 3

(2) Next to the analog gain control section 3 (preceding to the A/D converter 5)

(3) Preceding to the digital gain control section 6 (next to the A/D converter 5)

(4) Next to the digital gain control section 6

It is to be noted that (1) and (2) provide analog correction whereas (3) and (4) provide digital correction.

Furthermore, in the present invention, the delivery method of detector output data from the light amount detector 2 to the light amount detection data processing section (correction value calculation section) 4 is not limited particularly, and any of the following configurations may be adopted.

(1) Transmission of analog data from the CMOS sensor section 100a to the signal processing section 100b→A/D conversion and process by the data processing section 4

(2) Transmission of digital data obtained by A/D conversion by an A/D conversion section provided in the CMOS sensor section 100a to the signal processing section 100b→process immediately by the data processing section 4

It is to be noted that the A/D converter used here need not have an extremely high resolution but can be implemented even from an A/D converter of, for example, approximately 8 bits, and since calculation is required only once for one line, also the conversion rate may be comparatively low, and therefore, an A/D converter of the sequential comparison type can be used sufficiently.

In the following, a mechanism for further improvement in performance is described.

Generally, the following phenomenon takes place from characteristics of fluorescent materials of a fluorescent lamp. In particular, since a fluorescent material of blue (B) is higher in OFF response characteristic than the other fluorescent materials of red (R) and green (G), the emitted light amount decreases comparatively instantaneously. Therefore, it is known that the upper and lower ends of a flicker are colored with pale yellow.

Therefore, it is a possible idea to form, in the light amount detector 2, color filters 2′ on the front face (light receiving face) of the light amount detector 2 as seen in FIG. 6 so that the correction described above may be performed for each of the spectralized colors. This makes it possible to cope with coloring of a flicker by the persistence characteristic of the fluorescent material of the fluorescent lamp.

It is to be noted that, in the instance, from the point of view of the facility in signal processing, it is desirable to adopt a combination of color filters same as the combination of color filters 1′ (in the present embodiment, complementary color filters) provided in the CMOS sensor light receiving section 1 also for the light amount detector 2 as seen in FIG. 6. Further, also the spectral sensitivity characteristic including the sensitivity characteristic of a semiconductor layer as a substrate is preferably similar to that of the CMOS sensor light receiving section 1 as far as possible.

With such a configuration as described above, it is necessary to provide a correction table for each color for handling of detection data by the light amount detection data processing section (correction value calculation section) 4, and while this increases the burden on the circuit, a better correction result can be anticipated.

With such an image pickup apparatus and a flicker removing method of the embodiment described above, the following operation and effects can be achieved.

First, since the method wherein a correction value for image data is calculated always by the light amount detector 2, periodical variations of the power supply can be measured accurately, and flickers can be removed effectively. Particularly, also the problem of an error in discrimination of a striped pattern of the image pickup subject side is eliminated, and such a situation that the shutter value is fixed in vain in a situation wherein the fixation is unnecessary is eliminated.

Further, since there is no necessity to detect flickers themselves, the image pickup apparatus and the flicker removing method can be implemented with a simple and easy configuration. Further, the shutter function of a CMOS sensor can be utilized effectively over a wide illuminance range.

Further, the function used in the present embodiment can cope with any light source having a periodical light emission characteristic.

Further, since light amount detection for each color corresponding to a color filter of the CMOS sensor can be performed also with regard to illumination having any persistence characteristic, coloring can be solved with certainty.

Also it can be expected that this solves coloring (color rolling) which matters also with a CCD image pickup device.

Further, the light amount detector 2 can be produced readily also by an existing CMOS sensor manufacturing process without necessitating a special process. Further, it is not technically difficult to dispose the light amount detector 2 widely around the sensor light receiving section 1, but only it is necessary that light come to the position. In other words, the light amount detector 2 need not necessarily be positioned within an image forming range of the lens.

Further, as regards the method of delivering light amount detection data to a next stage, only it is necessary that a current value is successively outputted as an analog value, and also in this regard, the light amount detector 2 can be implemented with a simple configuration.

Further, since also the A/D converter for digitalizing light amount detection data need not have a very high resolution and besides calculation is required only once for one line and therefore the conversion rate need not be very high, also an A/D converter, for example, of the sequential comparison type can be used sufficiently as the A/D converter. Therefore, an A/D converter can be applied sufficiently as the A/D converter only if it has a performance required generally for a peripheral device of a microcomputer, and the A/D converter can be implemented at a low cost.

Further, if a microcomputer is used for the light amount detection data processing section (correction value calculation section) 4, then even if it becomes necessary to devise a calculation algorithm, this can be coped with readily. For example, also it is easy to add a function of receiving detection data and discriminating whether or not actual correction should be performed.

Further, a correction value for a light amount detection value is determined by address mapping from a table of such correction values and light amount detection values, and consequently, a correction value can be determined at a high speed.

Further, the position at which image data is to be multiplied by a correction value is preferably provided within a blanking period for each line because noise removal is performed once for one line. However, the position may be provided at any position within one line and there is no particular restriction, and the position can be selected suitably in accordance with a convenience in design or the like and design with a high degree of freedom can be anticipated.

Further, in the system configuration shown in FIG. 1, the CMOS sensor section 100a and the signal processing section 100b need not necessarily be integrated with each other, but even another system configuration wherein the CMOS sensor section 100a and the signal processing section 100b are sold and distributed as separate units and combined by the user side can implement the function of the present invention only if interface specifications of them are satisfied. Also such a system configuration as just described is included in the scope of the present invention.

As described above, with the image pickup apparatus of the present invention, periodical variations of the received light amount by a power supply frequency are detected from a detection output of the light amount detector provided in the proximity of the light receiving face of the solid-state image pickup device and an image pickup signal from the solid-state image pickup device is corrected with the detected periodical variations to remove striped noise arising from the light source having a periodical light emission characteristic.

Accordingly, it is possible to appropriately detect striped noise arising from a light source and remove part of the striped noise, or ideally remove all of the striped noise and thus achieve a high quality image output.

Further, with the striped noise removing method of the present invention, periodical variations of the received light amount by a power supply frequency are detected from a detection output of the light amount detector provided in the proximity of the light receiving face of the solid-state image pickup device and an image pickup signal from the solid-state image pickup device is corrected with the detected periodical variations to remove striped noise arising from the light source having a periodical light emission characteristic.

Accordingly, it is possible to appropriately detect striped noise arising from a light source and remove part of the striped noise, or ideally remove all of the striped noise and thus achieve a high quality image output.

1. An image pickup apparatus, comprising:
a solid-state image pickup device for outputting an image pickup signal corresponding to the amount of light incoming to a light receiving face thereof;
a light amount detector for measuring the received light amount; and
a correction circuit for detecting periodical variations of the received light amount from a detection output of said light amount detector and correcting the image pickup signal from said solid-state image pickup device with the detected periodical variations of the received light amount.

2. An image pickup apparatus according to claim 1, wherein the periodical variations are caused by the frequency of a power supply, and said correction circuit removes at least part of striped noise arising from the periodical variations of the incoming light amount.

3. An image pickup apparatus according to claim 1, wherein said solid-state image pickup device is a CMOS sensor.

4. An image pickup apparatus according to claim 1, wherein said light amount detector is means for detecting the received light amount on the real time basis.

5. An image pickup apparatus according to claim 1, wherein said light amount detector is provided in the proximity of said light receiving face.

6. An image pickup apparatus according to claim 5, wherein a plurality of such light amount detectors are provided around said light receiving face of said solid-state image pickup device.

7. An image pickup apparatus according to claim 5, wherein said light amount detector is provided leftwardly and rightwardly of and/or above and below said light receiving face of said solid-state image pickup device.

8. An image pickup apparatus according to claim 1, wherein a correction gain is calculated based on the detection output of said light amount detector, and the correction gain is inputted to a gain amplifier to correct the image pickup signal therewith.

9. An image pickup apparatus according to claim 8, wherein an empirically set calculation method is used for the calculation of the correction gain.

10. An image pickup apparatus according to claim 8, wherein the correction gain is calculated from a predictive value obtained by integrating the detection output of said light amount detector and predicting the sensor output value based on the integrated detection output.

11. An image pickup apparatus according to claim 1, wherein the correction is performed by an analog calculation process of the image pickup signal before the image pickup signal is A/D converted.

12. An image pickup apparatus according to claim 1, wherein the correction is performed by a digital calculation process of the image pickup signal after the image pickup signal is A/D converted.

13. An image pickup apparatus according to claim 1, wherein said light amount detector has color filters provided on a light receiving face thereof and said correction circuit detects light amount variations of the different colors spectralized by said color filters.

14. An image pickup apparatus according to claim 13, wherein said color filters provided on said light receiving face of said light amount detector have spectralized light passing properties substantially same as those of color filters provided on said light receiving face of said solid-state image pickup device.

15. An image pickup apparatus according to claim 13, wherein correction gains of the colors spectralized by said color filters are calculated and, after the image pickup signal is separated into colors, the correction gains of the colors are inputted to gain amplifiers to correct the image pickup signal therewith.

16. A striped noise removing method for an image pickup apparatus which includes a solid-state image pickup device for outputting an image pickup signal corresponding to the amount of light incoming to a light receiving face thereof, wherein
a light amount detector for measuring the received light amount is provide in the proximity of said light receiving face of said solid-state image pickup device, and
periodical variations of the received light amount caused by the frequency of a power supply are detected from a detection output of said light amount detector and the image pickup signal from said solid-state image pickup device is corrected with the detected periodical variations of the received light amount to remove at least part of striped noise arising from a periodical light emission characteristic of said light source.

17. A striped noise removing method for an image pickup apparatus according to claim 16, wherein said solid-state image pickup device is a CMOS sensor.

18. A striped noise removing method for an image pickup apparatus according to claim 16, wherein said light amount detector is means for detecting the received light amount on the real time basis.

19. A striped noise removing method for an image pickup apparatus according to claim 16, wherein a plurality of such light amount detectors are provided around said light receiving face of said solid-state image pickup device and generally detect the amount of light of image pickup light incoming to said light receiving face.

20. A striped noise removing method for an image pickup apparatus according to claim 19, wherein said light amount detector is provided leftwardly and rightwardly of and/or above and below said light receiving face of said solid-state image pickup device.

21. A striped noise removing method for an image pickup apparatus according to claim 16, wherein a correction gain is calculated from the detection output of said light amount detector, and the correction gain is inputted to a gain amplifier to correct the image pickup signal therewith.

22. A striped noise removing method for an image pickup apparatus according to claim 21, wherein an empirically set calculation method is used for the calculation of the correction gain.

23. A striped noise removing method for an image pickup apparatus according to claim 21, wherein the correction gain is calculated from a predictive value obtained by integrating the detection output of said light amount detector and predicting the sensor output value based on the integrated detection output.

24. A striped noise removing method for an image pickup apparatus according to claim 16, wherein the correction is performed by an analog calculation process of the image pickup signal before the image pickup signal is A/D converted.

25. A striped noise removing method for an image pickup apparatus according to claim 16, wherein the correction is performed by a digital calculation process of the image pickup signal after the image pickup signal is A/D converted.

26. A striped noise removing method for an image pickup apparatus according to claim 16, wherein said light amount detector has color filters provided on a light receiving face thereof and light amount variations of the different colors spectralized by said color filters are detected.

27. A striped noise removing method for an image pickup apparatus according to claim 26, wherein said color filters provided on said light receiving face of said light amount detector have spectralized light passing properties substantially same as those of color filters provided on said light receiving face of said solid-state image pickup device.

28. A striped noise removing method for an image pickup apparatus according to claim 26, wherein correction gains of the colors spectralized by said color filters are calculated and, after the image pickup signal is separated into colors, the correction gains of the colors are inputted to gain amplifiers to correct the image pickup signal therewith.
